(19) United States
(12) Patent Application Publication
(10) Pub. No.: US 2008/0171176 A1
(43) Pub. Date: Jul. 17, 2008

(54) Thin Film Ferroelectric Microwave Components and Devices on Flexible Metal Foil Substrates

(75) Inventors: Gerhard Hirmer, Aurora (CA); Qin Zou, Toronto (CA); Edward Xu, Toronto (CA); George Xing, Markham (CA)

Correspondence Address: JONES & SMITH, LLP, 2777 ALLEN PARKWAY, SUITE 800, HOUSTON, TX, 77019-2141, US

(73) Assignee: Energenius, Inc., Markham, ON (CA)

(21) Appl. No.: 10/593,214

(22) PCT Filed: Mar. 15, 2005
(86) PCT No.: PCT/IB2005/000662

§ 371 Date: Oct. 9, 2007

Related U.S. Application Data
(60) Provisional application No. 60/553,159, filed on Mar. 15, 2004.

(51) Int. Cl. B32B 3/00; B32B 15/04; B05D 5/12

(52) U.S. Cl. 428/156; 428/469; 428/332; 427/123

(57) ABSTRACT

Thin-film ferroelectric microwave components having a flexible and lightweight flexible metallic foil substrates and device structures offers a capability shaping the device to desired geometrical constructions and facilitating improvements in designs, sizes and costs.

### FIELD OF THE INVENTION

The present invention relates to the crystalline ferroelectric microwave components and device structures which are electronically controllable or tunable. The microwave components contains a flexible, lightweight, and adaptable metal foil substrate and a dielectric thin film having a non-linear dependence on an applied electric field. The microwave components are suitable for frequency-tunable microwave applications, such as microstrip patch ferroelectric antenna, thin film ferroelectric microwave phase shifters, tunable filters for wireless communications, and hybrid ferroelectric/superconducting microwave circuits.

### BACKGROUND OF THE INVENTION

High frequency microwave devices are extensively used in mobile communications systems. These devices employ planar circuits consisting of a conductor deposited on a film which exhibits an electric-field-dependent dielectric constant. Ferroelectric materials are non-linear dielectrics that display an electric-field-dependent dielectric constant. This, in turn can be employed in frequency-tunable microwave circuits. The crucial parameters required for tunable microwave devices include the degree of change in dielectric constant as a function of applied electric field, as well as dielectric loss at microwave frequencies. Ferroelectric thin-film devices are attractive in various applications requiring high tuning speed, small size, low power consumption, and low weight. For a tunable structure, a figure of merit K is defined as

K=(C₀−C_{V})/(C₀ tan δ₀)

where C₀ and C_{V} are the capacitance values at zero and maximum dc bias voltage, and tan δ₀ is the loss tangent with no bias.

Ferroelectric materials, such as barium strontium titanates, (BaSr)TiO₃, for microwave device applications have been reported in the literature. See, for instance, Zhu et al, “Recent Progress of (BaSr)TiO₃ Thin Films for Tunable Microwave Devices”, J. Electron. Mater., vol. 32 (10), pp. 1125-1134, 2003. Such films demonstrate excellent dielectric properties and large electric-field dielectric tunability which makes them especially suitable for tunable microwave components and devices. The use of ferroelectrics in the area of communications is desired in order to more efficiently manufacture electronically scanned antennas (ESA).

### SUMMARY OF THE INVENTION

The thin film components of the invention is useful in frequency-tunable microwave applications, such as microstrip patch ferroelectric antennas, thin film ferroelectric microwave phase shifters, tunable filters for wireless communications and hybrid ferroelectric/superconducting microwave circuits. The ferroelectric thin film composites have particular applicability in circuits employing voltage-controlled capacitance and variable wave velocity. It is the flexibility of the substrate which permits the application of different voltages onto the component such that different capacitance values may be rendered.

The thin film composites contain a flexible metallic substrate, a first ferroelectric thin film layer and a patterned thin metal layer. An optional barrier layer rests between the flexible metallic substrate and ferroelectric thin film layer.

The component is prepared by depositing onto the flexible metallic substrate a precursor composition using sol-gel, sputtering, pulsed laser deposition (PLD), molecular beam epitaxy (MBE) and various printing methods. The resultant is a tunable dielectric which is capable of changing frequency at selected electric fields.

The ferroelectric layer may be composed of one or more dielectric layers. The total thickness of the ferroelectric thin film layer is between from about 50 nm to about 900 mn.

The substrate is a flexible metallic foil which allows the composite to conform and maintain its integrity under external conditions. Suitable flexible metallic foils include nickel alloys, aluminum, brass, titanium, nickel-coated copper, platinum, stainless steel, platinum-plated silicon and nickel-coated copper foils.

### BRIEF DESCRIPTION OF THE DRAWINGS

In order to more fully understand the drawings referred to in the detailed description of the present invention, a brief description of each drawing is presented, in which

FIG. 1 is a schematic diagram of a structure containing a microstrip patch ferroelectric antenna formed on a metal foil substrate for ground-plane, according to the present invention.

FIG. 2 is a process flow diagram showing steps for forming thin-film ferroelectric microwave components and device structures deposited on a flexible metal foil substrate and lamination on substrates of various shapes.

FIG. 3 illustrates performance curves for a tunable structure upon application of an electric field.

### DETAILED DESCRIPTION OF THE PREFERRED EMBODIMENTS

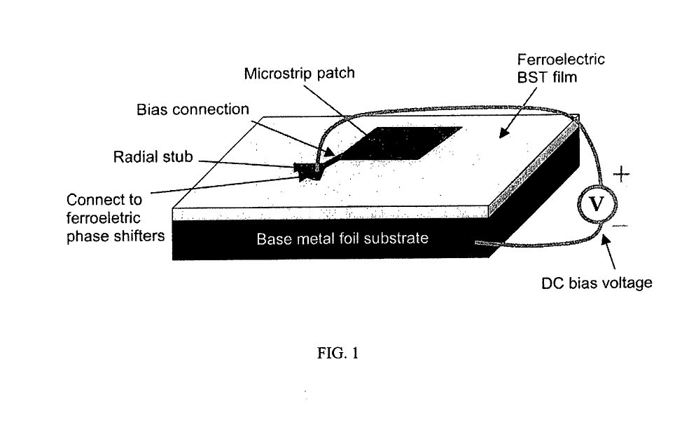

The thin film ferroelectric devices, set forth in FIG. 1, may be prepared by depositing onto a flexible metallic substrate, a precursor composition for a first ferroelectric thin film layer. An optional barrier layer may be deposited prior to deposition of the precursor composition. Each of these layers is preferably prepared from a precursor composition using sol-gel techniques. The precursor composition may be deposited by various methods, including sol-gel, sputtering, pulsed laser deposition (PLD), molecular beam epitaxy (MBE) and various printing methods.

Among these methods, sol-gel is especially preferred since deposition may occur at sufficiently low temperatures. Suitable low temperature sol-gel coating techniques include spin coating, dip coating, spray coating, meniscus coating, flow coating, physical vapor deposition (PVD), and metal organic chemical vapor deposition (MOCVD) and various printing methods. Deposition of the precursor using low temperatures sol-gel processes is especially advantageous with mismatched structures since the effect of thermal expansion mismatch is minimized. In addition, in comparison with other methods, sol-gel processing is relatively inexpensive and facilitates fast sampling of materials. Other deposition techniques may be used which promote uniformity especially those which minimize defect concentration and residual stresses.

The precursor compositions may be deposited onto the flexible metallic substrate by sol-gel techniques to form a tunable dielectric wherein the substrate serves as a bottom electrode.

The ferroelectric thin film precursor composition contains an organic solvent and organometallic components capable of forming the desired inorganic oxide dielectric. In a preferred embodiment, the mixture is mixed at approximately 110° C. for about 90 minutes.

The barrier precursor composition contains an organic solvent and organometallic compounds. After deposition, the composition is heated, prior to applying the precursor for the ferroelectric thin film layer, to remove the organic components and to render a dense buffer layer on the substrate. Typically, the composition is baked at a temperature from about 100° C. to about 450° C. and for a duration of about one to ten minutes. The organometallic compounds in the buffer precursor composition form, upon heating, inorganic oxides which, while exhibiting dielectric properties, provide improved attachment and bonding of the first dielectric thin film layer onto the substrate. The inorganic oxides of the buffer layer may be those recognized in the art. The optional buffer layer has a thickness between from about 40 nm to about 300 nm. The buffer layer may serve as a barrier against mechanical stress and failure from the substrate.

The ferroelectric layer may be composed of one or more dielectric layers wherein each layer is deposited and heated prior to deposition of the next layer. Thus, the ferroelectric layer, as that term is used herein, may consist of multiple layers. The precursor composition for each of the layers is preferably the same. When composed of multiple layers, the ferroelectric layers may be in a regular or irregular superlattice structure. The total thickness of the ferroelectric thin film layer is between from about 50 nm to about 900 nm, preferably between from about 50 nm to about 300 nm. The total thickness of the ferroelectric thin film layer is generally greater than the thickness of the barrier layer, when present. Thickness may be controlled by rotation rate and the viscosity of the precursor composition.

The precursor composition of the barrier layer and/or ferroelectric thin film layer may further contain a stabilizing amount of a glycol, such as polyethylene glycol.

The resulting product is annealed and a patterned thin metal layer may then be formed. The onset of the ferroelectric transition depends on the annealing temperature. Thus, the product is annealed at elevated temperature until crystallization. Generally, the annealing conditions will be selected to increase the grain size of the substrate comprising the thin film composite as well as to induce a textured condition in the substrate. Annealing may proceed in an oven at a temperature of from about 500° C. to about 850° C. for approximately one hour or by rapid thermal annealing using quartz halogen lamps, laser-assisted annealing using, for example, an excimer or carbon dioxide laser, or using electron beam annealing. Subsequent annealing, in turn, enhances the texture and degree of crystallinity of the dielectric thin film. The resulting porous structure provides an increased surface area and thus improves adhesion. Annealing further promotes film crystallinity.

The inorganic oxide of the optional barrier layer and ferroelectric thin film layer are typically composed of the same elements although the ratio of the elements may be different. Each of the film layers is preferably polycrystalline or nanocrystalline film.

Exemplary as the inorganic oxide of either the barrier or ferroelectric thin film layer is lead lanthanide titanate, lead titanate, lead zirconate, lead magnesium niobate, barium titanate, lead zirconate titanate, barium strontium titanate, lanthanum-modified lead zirconate titanate, bismuth zinc niobate and bismuth strontium tantalite. Preferred oxides are lead zirconate titanate, barium strontium titanate, lanthanum-modified lead zirconate titanate, bismuth zinc niobate and bismuth strontium tantalite.

Especially preferred are those titanates of the formula PbZr₁₋ₓ TiₓO₃ family with 0<x<1; preferred are those of the formula PbZrₓTiₓO₃ wherein x is between from about 0.30 to about 0.70, more preferably between from about 0.35 to about 0.65. Especially preferred as barium strontium titanates are those of the formula (Ba₁₋ₓSrₓ)TiO₃ wherein 0<x<1.0, most preferably wherein x is between from about 0.1 to about 0.9, most preferably 0.3 to about 0.7. One preferred embodiment is represented by the formula Ba_{0.5}Sr_{0.5}TiO₃. Especially preferred as lanthanum-modified lead zirconate titanates are those of the formula Pb_{y}La_{z}(Zr₁₋ₓTiₓ)O₃ wherein x is from about 0.30 to about 0.70, preferably between from about 0.35 to about 0.65, y is from 0.95 to about 1.25, and z is from about 0 to about 0.15. Further preferred as bismuth zinc niobates are those of the formula Bi₃ₓZn₂₍₁₋ₓ₎Nb₂₋ₓ-O₇ wherein x is from about 0.40 to about 0.75; and bismuth strontium tantalates of the formula SrₓBi_{y}Ta₂O_{5+x+3y/2} wherein x is from about 0.50 to about 1.0 and y is from about 1.9 to about 2.5.

The substrate is a flexible metallic foil which allows the composite to conform and maintain its integrity under external conditions. The metallic foil substrate is sufficiently thin to allow it to be shaped by bending or rolling according to specific geometrical requirements for targeted device constructions. Suitable flexible metallic foils include nickel alloys, aluminum, brass, titanium, nickel-coated copper, platinum, stainless steel, platinum-plated silicon and nickel-coated copper foils. Most preferable, the thickness of the metallic foil substrate is in the range between from about 10 to about 300 microns. The substrate may be a flat surface, textured surface or macroporous surface. The flexibility of the substrate permits the application of different voltages onto the component such that different capacitance values may be rendered. The ability to exhibit different capacitance values in electrical circuits causes the creation of different resonance frequencies.

The constituency of the organometallic components in the precursor composition is dependent on the desired ferroelectric film. Typically the titanium, niobium and tantalum elements of the ferroelectric originate from a metal alkoxide, such as titanium isopropoxide. The remaining metals are typically derived from metal acetates. For instance, the precursor solution of the barrier layer may be prepared by using starting materials containing the requisite amounts of barium, strontium, lead, and lanthanum precursors, such as barium acetate, strontium acetate, lead acetate, lanthanum isopropoxide and titanium isopropoxide.

The organic solvent used in the precursor compositions is typically a glycol, such as ethylene glycol and propylene glycol, or an alkanol, such as ethanol, isopropyl alcohol, methanol and n-butanol, or weak organic acids, such as acetic acid.

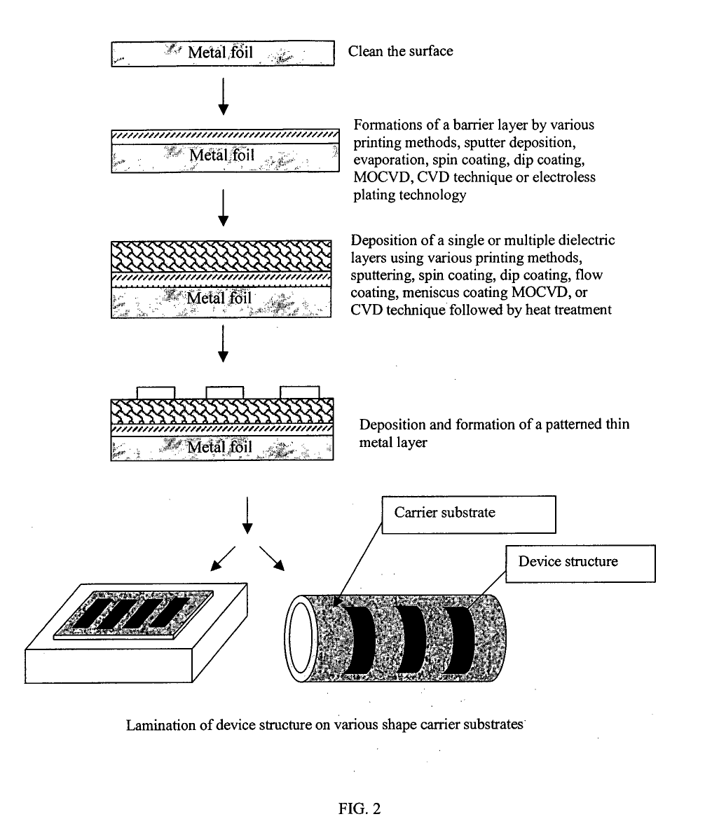

FIG. 2 exemplifies a suitable process for forming the thin-film ferroelectric microwave components and device structures. After cleaning the flexible metallic foil substrate, a precursor composition for a barrier layer is deposited onto the substrate followed by precursor composition for forming the dielectric film. The composite is annealed and a patterned thin metal layer is then deposited. The resulting composite may then be shaped for the desired application as illustrated.

As an exemplary of a process within the procedure set forth in FIG. 2, a non-aqueous solution of reactants may be reacted at the desired stoichiometry and controllably hydrolyzed with a solvent/water solution. A thin, adherent film of the hydrolyzed alkoxide solution (“sol”) is then applied to the substrate at 1,000 to 3,000 rpm. It is most preferred that all reactants used in each of the alternative processes be of high purity. Generally, the level of purity is greater than 95%, preferably greater than 99%. In addition, it is preferred that the individual steps of the invention be conducted in an oxygen and humidity (moisture) free atmosphere, preferably under vacuum.

Structures derived from the composites of the invention include microwave components and devices such as non-linear dielectric thin film composites for frequency-tunable microwave applications, such as microstrip patch ferroelectric antennas, thin film ferroelectric microwave phase shifters, tunable filters for wireless communications and hybrid ferroelectric/superconducting microwave circuits. The ferroelectric thin-film layer of the composite affords a large field-dependent dielectric constant (necessary for compact tunable circuits), fast field response (for facilitating fast switching speeds), and high breakdown fields. As such, the ferroelectric thin films have particular applicability in circuits employing voltage-controlled capacitance (e.g., voltage-controlled oscillators, tunable filters, and phase shifters) and variable wave velocity (e.g., distributed phase shifters, delay lines). The structure is flexible and thus easy to integrate into different shaped objects including structures which do not exhibit planar flat surfaces.

The resulting components are tunable or controllable such that a particular wave range, wavelength or wave direction may be changed by application of an electric field.

The use of ferroelectric materials as phase shifters present substantial advantages towards inexpensive fabrication possibilities on a single substrate. Such fabricated ferroelectric thin films on a single substrate have particular applicability in the case of phased arrays which employ hundreds of radiating elements and a large number of phase shift elements. In such cases, cuts are related to the number of elements and active electronic devices, such as phase shifters. In phased array antennas, phase shifters and delay lines, employment of voltage-controlled modulation of the dielectric constant and time delay in delay lines may be employed to phase delay microwave signals transmitted (or received) from the separate radiative elements of the array.

In a preferred mode, the composites of the invention are formed on a metal foil substrate are useful as microstrip patch ferroelectric antenna for ground plane. FIG. 1 illustrates a an antennae containing a metallic foil substrate, a ferroelectric barium strontium titanate thin film and a microstrip patch-radiating element on the thin ferroelectric film which is formed on the base metallic foil substrate for ground-plane.

The value of merit K, and hence the resonance frequency, is controlled by applying an electric field across the ferroelectric film. For this purpose, a controllable DC bias potential is applied between the microstrip patch and the ground plane. The resulting structure facilitates the application of a controllable voltage across the dielectric layer, thus controlling a dielectric constant of said dielectric material. For isolation of the DC bias source from the radio-frequency signal, the DC bias is fed in via a high-impedance microstrip transmission line with one end connected to a corner of the patch and the other end terminated in a quarter-wave radial stub (the quarter-wavelength radius would be chosen for a frequency near the middle of the desired radiation-frequency range). A wire delivers the bias voltage to a radio-frequency virtual-short-circuit location on the transmission line so that the impedance is not perturbed.

A multimode patch antenna may be designed to resonate at an odd sub-multiple of possibly widely separated desired operating frequencies. By using a combination of (1) varying the DC bias voltage to vary the dielectric constant of the ferroelectric film and (2) selection of the desired harmonic frequency, one can effectively achieve tuning over a very wide frequency range.

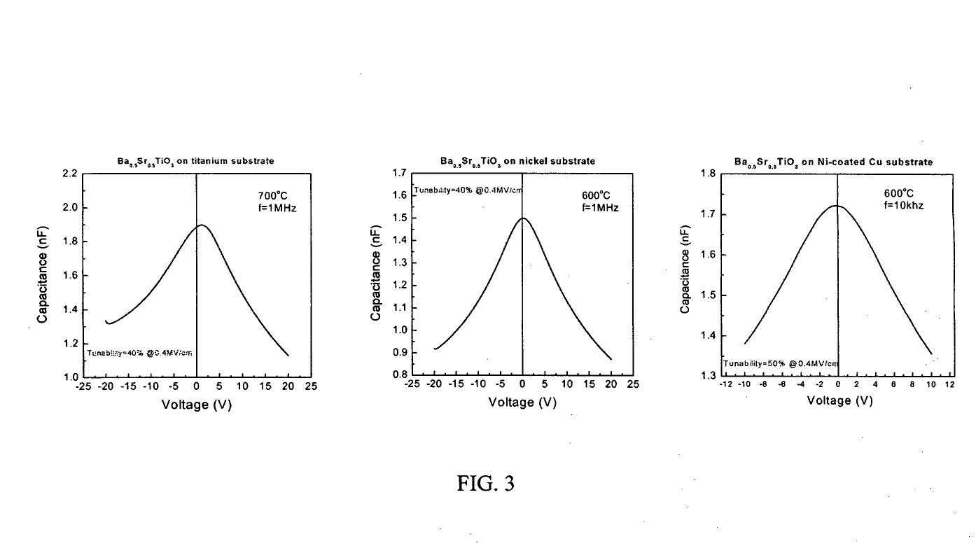

FIG. 3 illustrates the capacitance variation of a capacitor containing a Ba_{0.5}Sr_{0.5}TiO₃ ferroelectric on a flexible titanium, nickel, and nickel-coated copper substrate. The performance curves illustrate variable capacitance value over voltage changes and exhibit the percentage of tunability to be between 40 to 65%.

What is claimed is:

1. A frequency tunable ferroelectric microwave component comprising:
(a.) a flexible metallic foil substrate;
(b.) at least one crystalline ferroelectric layer; and
(c.) a patterned thin metal layer
such that a controllable DC bias potential may be applied between the patterned thin metal layer and the metallic foil substrate.

2. The ferroelectric microwave component of claim 1, wherein the at least one crystalline ferroelectric layer is selected from the group consisting of a lead lanthanide titanate, lead titanate, lead zirconate, lead magnesium niobate, barium titanate, lead lanthanum zirconate titanate, lead zirconate titanate, barium strontium titanate, lanthanum-modified lead zirconate titanate, bismuth zinc niobate and bismuth strontium tantalite.

3. The ferroelectric microwave component of claim 2, wherein the at least one crystalline ferroelectric layer comprises lead zirconate titanate, barium strontium titanate, lanthanum-modified lead zirconate titanate, bismuth zinc niobate and/or bismuth strontium tantalite.

4. The ferroelectric microwave component of claim 3, wherein the at least one crystalline ferroelectric layer is selected from the formula:
(a.) (Ba₁₋ₓSrₓ)TiO₃, PbZr₁₋ₓTiₓO₃ or Pb_{y} La_{z}(Zr₁₋ₓTiₓ)O₃ wherein x is between from about 0.1 to about 0.9, y is from about 0.95 to about 1.25 and z is between from about 0 to about 0.15;
(b.) Bi₃Zn₂₍₁₋ₓ₎Nb₂₋ₓO₇ wherein x is between from about 0.40 to about 0.75.
(c.) SrₓBi_{y}Ta₂O_{5+x+3y/2} wherein x is between from about 0.50 to about 1.0 and y is between from about 1.9 to about 2.5.

5. The ferroelectric microwave component of claim 1, wherein the metallic foil is selected from the group consisting of aluminum, brass, nickel alloy, nickel-coated copper, platinum, titanium and stainless steel foil.

6. The ferroelectric microwave component of claim 1, wherein the ferroelectric thin film layer has a thickness in the range from between about 50 nm to 1000 nm.

7. The ferroelectric microwave component of claim 1, wherein the metallic foil has either a flat surface, textured surface or macroporous surface.

8. The ferroelectric microwave component of claim 1, wherein the flexible metallic foil substrate has a thickness in the range between about of 10 and 300 microns.

9. The ferroelectric microwave component of claim 1, wherein the ferroelectric thin-film layer consists of multiple layers of dielectric materials in a regular or irregular superlattice structure.

10. The ferroelectric microwave component of claim 1, wherein a barrier layer is interposed between the flexible metallic foil substrate and the ferroelectric thin-film layer.

11. A method of making a thin-film ferroelectric microwave component comprising:
(a.) depositing onto a flexible metallic foil substrate a precursor composition for a ferroelectric thin-film layer and heating until forming a ferroelectric thin-film layer; and
(b.) depositing onto the ferroelectric thin-film layer a patterned thin metal layer.

12. The method of claim 11, wherein the deposited precursor composition is heated until a ferroelectric thin-film layer is formed having a thickness between from about 50 to about 300 nm.

13. The method of claim 11, wherein the metallic foil has either a flat surface, textured surface or macroporous surface.

14. The method of claim 11, wherein the flexible metallic foil substrate is selected from the group consisting of aluminum, brass, nickel alloy, nickel coated copper foil, platinum, titanium or stainless steel.

15. The method of claim 11, wherein the flexible metallic foil substrate has a thickness in the range between about of 10 and 300 microns.

16. The method of claim 11, wherein, prior to depositing the patterned thin metal layer, depositing at least one additional precursor composition for the ferroelectric thin-film layer onto the substrate.

17. The method of claim 11, wherein, prior to depositing the at least one ferroelectric thin-film layer, a barrier layer is deposited onto the flexible metallic foil substrate.

18. A method of an antenna which comprises:
(a.) sol-gel depositing onto a flexible metallic foil substrate a precursor composition of a ferroelectric thin-film layer and heating until a ferroelectric thin-film layer is obtained; and
(b.) forming onto the ferroelectric thin-film layer a patterned microstrip patch having associated a bias connection and radial stub.

19. A method of manufacturing a ferroelectric antenna which comprises:
(a.) depositing onto a flexible metallic foil substrate for ground plane a precursor composition for a ferroelectric thin-film layer and heating until a ferroelectric thin-film layer is obtained; and
(b.) forming onto the ferroelectric thin-film layer a patterned thin metallic microstrip patch having associated bias connections and radial stubs.

20. The method of claim 19, wherein the thickness of the ferroelectric thin film layer is between from about 50 nm to about 1000 nm.

21. An antennae comprising the ferroelectric microwave component of claim 1.
